(19) United States
(12) Patent Application Publication
(10) Pub. No.: US 2024/0292512 A1
(43) Pub. Date: Aug. 29, 2024

(54) PLASMA TORCH HEAD

(71) Applicant: The ESAB Group Inc., North Bethesda, MD (US)

(72) Inventor: Andrew J. Raymond, Lebanon, NH (US)

(21) Appl. No.: 18/174,175

(22) Filed: Feb. 24, 2023

(51) Int. Cl. H05H 1/34

(52) U.S. Cl. CPC H05H 1/3494; H05H 1/3457; H05H 1/3478

(57) ABSTRACT

A torch head for a plasma torch includes an electrode having a vent formed therethrough, the vent being configured to receive plasma gas and direct plasma gas through the electrode. The torch head also includes a spring configured to bias the electrode toward a nozzle of the torch head. The vent of the electrode is configured to discharge plasma gas across the spring.

### TECHNICAL FIELD

The present disclosure relates to plasma torches and, in particular, to directing gas through a plasma torch head.

### BACKGROUND

A plasma torch, such as a plasma cutting torch, is used to perform various operations with respect to a metal workpiece. For example, the plasma torch may be used to remove material from the metal workpiece for a cutting operation. The plasma torch generates and maintains a plasma arc during operation. For instance, the plasma arc may be at a sufficiently high temperature that can melt the metal workpiece. Components of the plasma torch may also be subject to extremely high temperatures during operation of the plasma torch. As an example, the high temperature of the plasma arc may transfer to the components of the plasma torch. As another example, power provided to the plasma arc may generate heat that increases the temperature of the components of the plasma torch.

An increased temperature of the components of the plasma torch may adversely affect operation of the plasma torch. By way of example, the increased temperature may affect a structural integrity of a certain component to reduce effective operation of the component and therefore of the plasma torch. Additionally or alternatively, the increased temperature may reduce a useful lifespan of the component. As a result, the component will need to be inspected, replaced, and/or repaired to enable the plasma torch to continue to operate in a desirable manner. In this way, operational efficiency of the plasma torch (e.g., continual operation of the plasma torch without having to examine the component) may be reduced.

### SUMMARY

The present disclosure is directed to operations of a plasma torch. The plasma torch may include a torch head through which gas flows during operation. The torch head may form a flow path that directs the gas across different components of the torch head to provide cooling of the components (e.g., via convection).

The torch head may include an electrode, which may be movable relative to other components of the torch head. For example, a spring may bias the electrode to urge movement of the electrode toward a nozzle or tip of the torch head. In at least some embodiments, the flow path may direct gas across the spring to reduce a temperature of the spring that may be caused by operation of the plasma torch. Reducing the temperature of the spring may help maintain a structural integrity and/or improve a useful lifespan of the spring to enable the spring to operate more effectively.

According to one example embodiment, a torch head for a plasma torch includes an electrode having a vent formed therethrough, the vent being configured to receive gas and direct gas through the electrode. The torch head also includes a spring configured to bias the electrode toward a nozzle of the torch head. The vent of the electrode is configured to discharge gas across the spring.

According to another example embodiment, a method for directing gas through a plasma torch includes directing a gas flow into an electrode of the plasma torch via an opening of the electrode, directing the gas flow from the opening to a vent of the electrode, and discharging the gas flow from the vent of the electrode to a spring of the plasma torch, the spring being configured to bias the electrode toward a nozzle of the plasma torch.

According to yet another example embodiment, an electrode for a plasma torch includes a proximal end, a distal end, and a side surface extending at least partially between the proximal end and the distal end, as well as one or more fins extending from the side surface and defining a passageway between the distal end of the electrode and the proximal end of the electrode. The passageway is configured to direct gas from the distal end toward the proximal end, and the one or more fins includes a first surface facing the distal end, the first surface extending at a first angle relative to the side surface, and a second surface facing the proximal end, the first surface and the second surface cooperatively defining the passageway, the second surface extending at a second angle relative to the side surface, and the second angle and the first angle being different from one another.

Other systems, methods, features and advantages will be, or will become, apparent to one with skill in the art upon examination of the following figures and detailed description. All such additional systems, methods, features, and advantages are included within this description and are within the scope of the claimed subject matter.

### BRIEF DESCRIPTION OF THE DRAWINGS

The torch head for a plasma torch presented herein may be better understood with reference to the following drawings and description. It should be understood that the elements in the figures are not necessarily to scale and that emphasis has been placed upon illustrating the principles of the torch heads. In the figures, like-referenced numerals designate corresponding parts throughout the different views/

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch, according to an example embodiment of the present disclosure.

FIG. 2 is a cross-sectional view of a torch head of a plasma torch, according to an example embodiment of the present disclosure.

FIG. 3 is a cross-sectional view of a portion of a torch head of a plasma torch, according to an example embodiment of the present disclosure.

FIG. 4 is a perspective view of an insulator of a torch head of a plasma torch, according to an example embodiment of the present disclosure.

FIG. 5 is a cross-sectional view of a portion of a torch head of a plasma torch, according to an example embodiment of the present disclosure.

FIG. 6 is a cross-sectional view of an electrode of a torch head of a plasma torch, according to an example embodiment of the present disclosure.

FIG. 7 is a flowchart of a method for directing plasma gas through a torch head of a plasma torch, according to an example embodiment of the present disclosure.

### DETAILED DESCRIPTION

A torch head of a plasma torch is presented herein. The torch head may define a flow path configured to direct plasma gas across different components of the plasma torch during operation of the plasma torch. For example, the flow path may direct plasma gas across an electrode, a cathode, an insulator, and/or a spring of the torch head. The plasma gas directed across such components of the torch head may provide cooling of the components. Cooling of the components may enable the components to operate desirably and/or may prolong a useful lifespan of the components to continue to operate. For example, the flow of plasma gas may mitigate deformation of a component that may otherwise be caused by prolonged exposure to a high temperature. Therefore, the torch head presented herein may improve overall operation of the plasma torch.

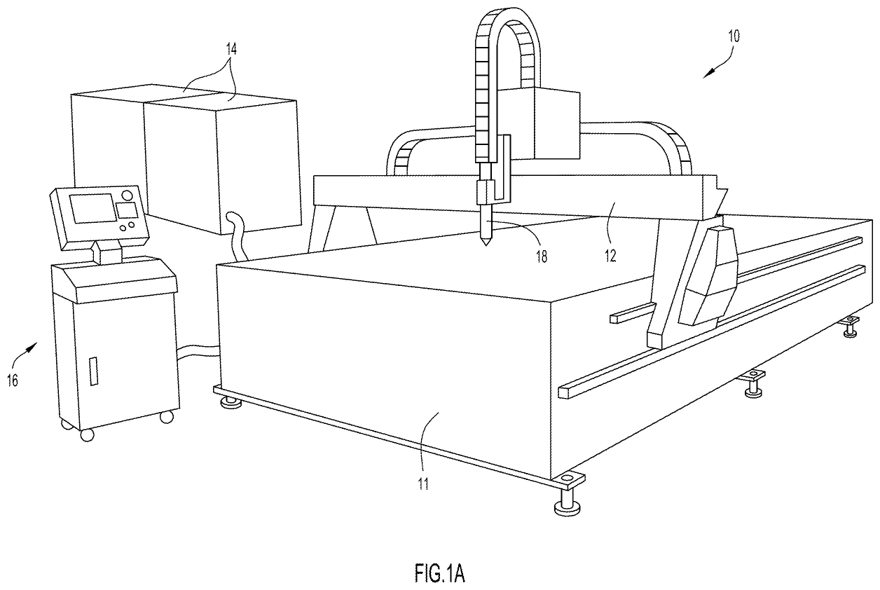

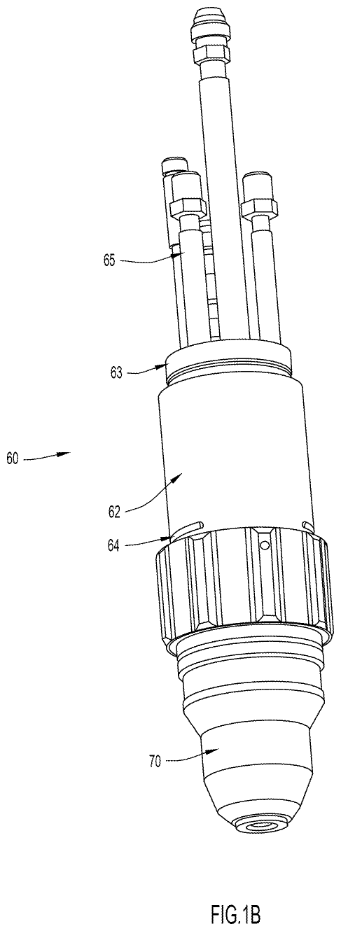

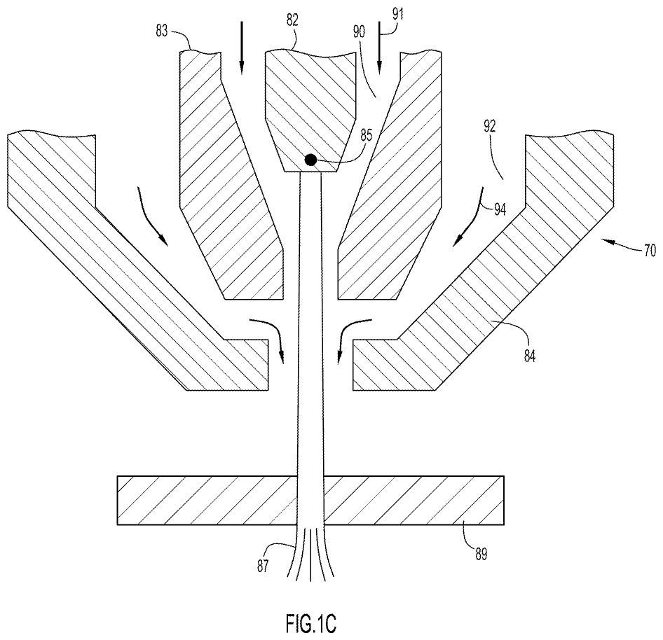

FIG. 1A illustrates an example embodiment of an automated cutting system 10 that may execute the techniques presented herein. However, this automated cutting system 10 is merely presented by way of example, and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated cutting system 10 may include a separate fluid supply unit (not shown) or units that can provide one or more fluids to the automated torch 18 independent of the one or more power supplies 14. To be clear, as used herein, the term “fluid” shall be construed to include a gas or a liquid. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated cutting system 10 may be any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack 70 depicted in FIGS. 1B and 1C (with an external perspective view and a schematic cross-sectional illustration, respectively) is merely representative of a consumable stack that may be used with an automated torch executing the techniques presented herein. Similarly, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield 84 (sometimes called a shield cap) of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 (also referred to as “working gas” or “process gas”) flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated. In at least some instances, the shield fluid 94 and the plasma gas 91 include the same fluid.

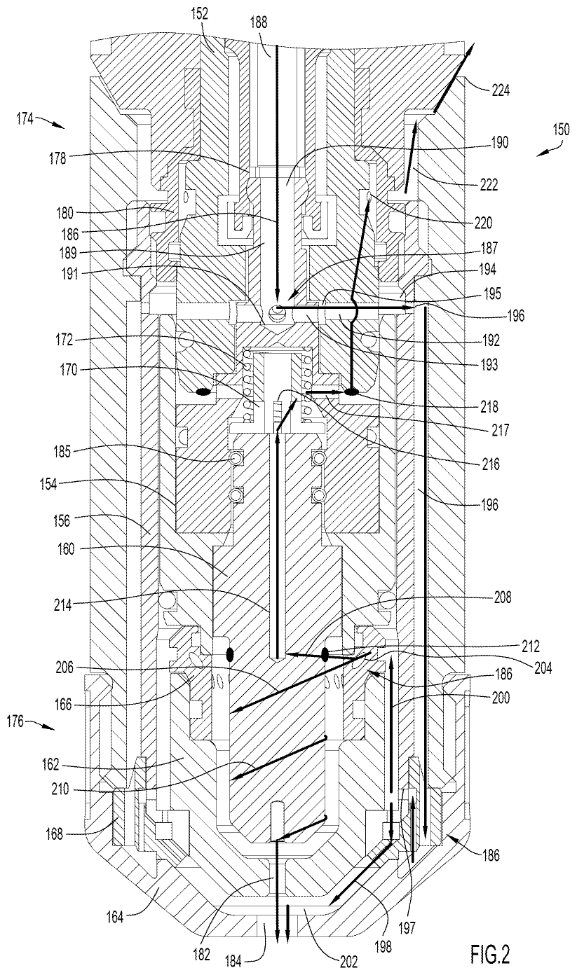

FIG. 2 illustrates a cross-sectional view of an example embodiment of a torch head 150 (e.g., the cutting head 60) that may be employed by a plasma torch (e.g., the plasma arc torch 18). The torch head 150 may include a body 152 (e.g., the body 62), a cathode 154 coupled to the body 152, an anode 156 coupled to the body 152, and an outer shell 158 coupled to the body 152 and to the anode 156. The torch head 150 may also include an electrode 160, a nozzle or tip 162, a shield 164, a plasma gas distributor 166 coupled to the nozzle 162, a shield gas distributor 168 coupled to the shield 164, an insulator 170 coupled to the electrode 160, and a spring 172 coupled to the insulator 170. In some embodiments, the body 152, the cathode 154, the anode 156, and/or the outer shell 158 may be fixed to one another. For example, the body 152, the cathode 154, the anode 156, and/or the outer shell 158 may be a fixture 174 that may generally remain a part of the torch head 150. That is, the fixture 174 may not be easily removed or separated from a remainder of the plasma torch. For instance, the fixture 174 may remain attached to a support structure of the plasma torch (including automated support structures or manual support structures, such as handles).

Meanwhile, the electrode 160, the nozzle 162, the shield 164, the plasma gas distributor 166, the shield gas distributor 168, and/or the insulator 170 may be a part of a consumable stack 176 (e.g., the consumable stack 70) of the torch head 150. The consumable stack 176 is generally coupled to the fixture 174. More specifically, in the depicted embodiment, the electrode 160 is coupled to the cathode 154, the shield 164 is coupled to the outer shell 158, and/or the shield gas distributor 168 is coupled to the anode 156. However, in other embodiments, the consumable stack 176 can be coupled to the fixture 174 in any desirable manner. Also, regardless of the specific couplings, at least a portion of the consumable stack 176 is relatively easily removable from a remainder of the plasma torch. That is, the consumable stack 176 may be more frequently replaced as compared to the fixture 174. Thus, the consumable stack 176 may be easily detachable from the fixture 174. For example, decoupling the consumable stack 176 from the fixture 174 may collectively separate the electrode 160, the nozzle 162, the shield 164, the plasma gas distributor 166, the shield gas distributor 168, and/or the insulator 170 from a remainder of the torch head 150. But, in different embodiments, these components may be decoupled separately or in one or more groups.

During operation of the plasma torch, the torch head 150 may generate or draw out a plasma arc between the electrode 160 and the nozzle 162. By way of example, a power supply coupled to the torch head 150 may deliver negative potential to the cathode 154 (e.g., via a cathode conductor 178 electrically coupled to the cathode 154) and to the electrode 160 electrically coupled to the cathode 154. Additionally or alternatively, the power supply may deliver positive potential to the anode 156 (e.g., via an anode conductor 180 electrically coupled to the anode 156). A gas source of the plasma torch may also deliver plasma gas through the torch head 150, and the plasma gas may flow between the electrode 160 and the nozzle 162. When the plasma gas traverses an arc (e.g., a plasma arc) extending between the electrode 160 and the nozzle 162, the gas becomes ionized and generates the plasma arc, which may extend through a nozzle orifice 182 and a shield orifice 184 to transfer onto a workpiece.

The present application utilizes a “blow-back” starting technique and, thus, a portion of the electrode 160 is in contact with a portion of the nozzle 162 prior to arc initiation. Then, gas pressure “blows” the electrode 160 away from the nozzle 162 to draw out an arc in the plasma chamber 211. More specifically, the spring 172 coupled to the insulator 170 imparts a force onto the insulator 170 to bias the insulator 170, and therefore the electrode 160 coupled to the insulator 170, toward the nozzle 162. Then, the flow of plasma gas between the electrode 160 and the nozzle 162 may separate the electrode 160 and the nozzle 162 from one another, drawing out an electric arc. Put another way, the plasma gas may impart a force that overcomes the force imparted by the spring 172, thereby forcing the electrode 160 and the nozzle 162 away from one another and enabling generation of pilot arc between the electrode 160 and the nozzle 162. However, this is merely one technique for starting a plasma torch, and the techniques presented herein may also be implemented with other starting techniques, such as “blow forward” techniques, scratch start techniques, and the like.

Still referring to FIG. 2, the torch head 150 further includes coils 185 (e.g., canted coils) to facilitate relative movement between the electrode 160 and the nozzle 162. That is, the torch head 150 further includes coils 185 that allow the electrode 160 to translate along the cathode 154 to move toward or away from the nozzle 162. Generally, the coils 185 surround the electrode 160 and are in engagement with the cathode 154 and the electrode 160. In some instances, the coils 185 may offset the electrode 160 and the cathode 154 from one another such that the electrode 160 and the cathode 154 are not in direct contact with one another. Alternatively, the coils 185 may contact the electrode 160 and the cathode 154 while the electrode 160 and the cathode 154 also contact one another. Either way, the coils 185 may be able to rotate relative to the cathode 154 and to the electrode 160. As an example, a force imparted onto the electrode 160 (e.g., via the spring 172, via the plasma gas) may be transferred to the coils 185 to cause the coils 185 to rotate (e.g., roll) relative to the cathode 154 and to the electrode 160. Rotation of the coils 185 may then drive movement of the electrode 160 along the cathode 154. That is, the coils 185 may carry the electrode 160 and roll along the cathode 154, thereby moving the electrode 160 along the cathode 154. Additionally, if the coils 185 offset the electrode 160 and the cathode 154 from one another, the coils 185 may reduce a frictional force that would otherwise block relative movement between the cathode 154 and the electrode 160. Indeed, the offset between the cathode 154 and the electrode 160 may block the cathode 154 and the electrode 160 from scraping against one another during relative movement. As such, the coils 185 may enable the electrode 160 to move relative to the cathode 154, and therefore relative to the nozzle 162, more easily.

Additionally, the coils 185 may be composed of a conductive material to enable the electrode 160 and the cathode 154 to remain in electrical contact with one another during movement of the electrode 160 relative to the cathode 154. Indeed, the coils 185 may remain electrically coupled to both the cathode 154 and the electrode 160 during movement of the electrode 160 relative to the cathode 154 to facilitate electrical flow between the cathode 154 and the electrode 160. As such, the coils 185 may reduce resistive heating of the electrode 160 that may otherwise occur as a result of inadequate electrical flow between the cathode 154 and the electrode 160, such as during reduced electrical contact between the electrode and the cathode 154. Thus, the coils 185 may also reduce heating of components (e.g., the insulator 170, the spring 172) that may be directly or indirectly in contact with the electrode 160.

Further still, the coils 185 may enable radial conduction of electrical power from the cathode 154 to the electrode 160 with respect to the electrode 160. That is, the coils 185 may direct electrical flow from the cathode 154 to the electrode 160 radially with respect to the electrode 160 around a complete circumference of the electrode 160. By comparison, if radial conduction between the cathode 154 to the electrode 160 depends on direct contact between the cathode 154 to the electrode 160, geometric irregularities, e.g., caused by slight surface defects, manufacturing defects, tolerancing issues, wear patterns, micro gaps, etc. might cause irregular conduction of electricity, which will further emphasize geometric irregularities (e.g., cause a size increase). Eventually, this direct radial conduction, may render the electrode 160 and/or cathode 154 inoperable.

Moreover, when the coils 185 direct electrical flow from the cathode 154 to the electrode 160 radially with respect to the electrode 160, an electrical current may flow from the cathode 154 to the electrode 160 without flowing through the spring 172, reducing heating of the spring 172 that may otherwise occur from electrical flow through the spring 172. Indeed, by maintaining electrical contact between the cathode 154 and the electrode 160, the coils 185 may enable electrical flow between the cathode 154 and the electrode 160 and avoid electrical flow through the spring 172, regardless of the position of the electrode 160 relative to the cathode 154. Consequently, in situations in which the electrode 160 is not in contact with nozzle 162 prior to arc initiation (e.g., when the spring 172 does not provide an adequate force to bias the electrode 160 toward the nozzle 162, when the electrode 160 has worn sufficiently to reduce extension toward the nozzle 162, and/or when the plasma gas flow has not yet been sufficiently reduced after a previous plasma arc generation and still imparts a sufficient force to drive the electrode 160 away from the nozzle 162), the electrode 160 may still receive a sufficient electrical flow at its position relative to the cathode 154. Thus, the torch head 150 may be able to initiate a plasma arc even when the electrode 160 is not in contact with the nozzle 162 prior to arc initiation.

Still referring to FIG. 2, the torch head 150 of the present application defines a flow path 186 (e.g., a process gas flow path 186) that directs the process gas across various components of the torch head 150. Indeed, the fixture 174 and the consumable stack 176 cooperatively define the flow path 186 in an assembled configuration of the torch head 150 in which the fixture 174 and the consumable stack 176 are coupled to one another. Flow of the process gas via the flow path 186 may cool the components of the torch head 150 via convection. That is, heat may transfer from the components to the process gas. The torch head 150 may then use (e.g., as shield gas or plasma gas) and/or discharge the heated process gas from within the torch head 150, thereby removing heat from the torch head 150.

More specifically, process gas may flow into the fixture 174 of the torch head 150 via a gas tube 188. The cathode 154 includes a first opening 190 fluidly coupled to the gas tube 188 and configured to receive the process gas directed through the gas tube 188. The cathode 154 directs the process gas around an outer boundary of the consumable stack 176. For example, the cathode 154 includes an inner passageway 187 that has a first or proximal portion 189 extending from the first opening 190 to a closed distal end 191. The inner passageway 187 also includes a second or distal portion 193 that extends crosswise (e.g., orthogonally) relative to the first portion 189. As such, the inner passageway 187 may adjust a flow direction of the process gas to flow from the first portion 189 to the second portion 193. The second portion 193 extends to an outer surface 195 of the cathode 154 to connect to a first opening 192 formed in the body 152. Thus, the cathode 154 may discharge the process gas to the first opening 194 via the inner passageway 187. In the depicted embodiment, the second portion 193 includes two holes, but in other embodiments, the second portion 193 may include a single, annular passageway or include any other number of holes (e.g., one hole, three or more holes).

The first opening 192 of the body 152 directs the process gas to a first opening 194 formed in the anode 156, and the first opening 194 direct the process gas towards the outer shell 158 into a channel 196 formed between the anode 156 and the outer shell 158. The channel 196 directs the process gas distally between the outer shell 158 and the anode 156 to the shield gas distributor 168. The shield gas distributor 168 and the shield 164 then cooperate to reverse the flow direction of the process gas, redirecting the distally flowing process gas into a proximally flowing flow.

Flow of the process gas along the outer shell 158 via the channel 196 may provide cooling of the outer shell 158 and/or of the anode 156 extending along the outer shell 158. For instance, the process gas can remove heat from the outer shell 158 and/or of the anode 156 via convection. Indeed, since the initial flow (e.g., the initial flow rate, the initial flow volume, the initial flow amount) of the process gas directed into the torch head 150 flows along the outer shell 158 and the anode 156 to the shield 164, any cooling provided by the process gas may be fully experienced by these components (e.g., the outer shell 158, the anode 156, and the shield 164). That is, since the process gas initially flows along the outer shell 158, the anode 156, and the shield 164, these components may realize a maximum cooling effect provided by the plasma flow. Thus, cooling of the outer shell 158 and/or of the anode 156 may efficiently reduce wear of the outer shell 158 and/or of the anode 156. This may be advantageous because the shield 164 is in closest proximity to a workpiece on which a plasma arc is acting, as well as slag produced therefrom, during a plasma operation (and, thus, may be subject to the highest temperatures).

After the process gas reverses directions (to flow in a proximal direction), the shield gas distributor 168 directs the process gas through a second opening 197 of the anode 156, which causes the process gas to split into a shield gas flow 198 and a plasma gas flow 200. The anode 156 directs the shield gas flow 198 back through the shield gas distributor 168, and the shield gas distributor 168 directs the shield gas flow 198 through a shield gas channel 202 formed between an exterior surface of the nozzle 162 and an interior surface of the shield 164, and out of the torch head 150 via the shield orifice 184. Such flow of the plasma gas may provide increased cooling of the shield gas distributor 168 and the shield 164. That is, the initial flow of plasma gas directed into the torch head 150 may be directed through a portion of the shield gas distributor 168 and discharged from the shield gas distributor 168. Additionally, some of the initial flow of plasma gas may be re-directed through another portion of the shield gas distributor 168. Thus, the plasma gas may flow through the shield gas distributor 168 in multiple passes (e.g., from the outer shell 158 to the shield gas distributor 168, from the anode 156 to the shield gas distributor 168) to enable the shield gas distributor 168 to discharge a greater amount of heat to the plasma gas. Cooling of the shield gas distributor 168 may also increase cooling of the shield 164 coupled to the shield gas distributor 168. For example, the reduced temperature of the shield gas distributor 168 may enable the shield gas distributor 168 to absorb heat from the shield 164 to cool the shield 164. Cooling of the shield 164 (e.g., by cooling of the shield gas distributor 168 via the plasma gas) may reduce wear of the shield 164 and enable the shield 164 to operate more desirably.

The other branch of the split process gas flows proximally between an exterior surface of the nozzle 162 and the anode 156. That is, the anode 156 directs the plasma gas flow 200 along the anode 156, between the anode 156 and the nozzle 162, to an opening 204 formed in the plasma gas distributor 166. After passing through openings 204, the plasma gas flow 200 splits into a first portion 206 (e.g., a plasma flow) and a second portion 208 (e.g., a backflow, a cooling flow). The first portion 206 of the plasma gas flow 200 flows in a helical or spiral flow 210 around the electrode 160 (e.g., caused by the configuration of opening 204) that increases the speed of the first portion 206 of the plasma gas flow 200. Prior to arc initiation, during which the electrode 160 and the nozzle 162 may be in contact with one another (e.g., via the force imparted by the spring 172), the first portion 206 of the plasma gas flow 200 may pressurize within a plasma chamber 211 formed between the electrode 160 and the nozzle 162. By way of example, the contact between the electrode 160 and the nozzle 162 may block the first portion 206 of the plasma gas flow 200 from being discharged out of the plasma chamber 211 via the nozzle orifice 182. Thus, the first portion 206 of the plasma gas flow 200 may build up within the plasma chamber 211. The pressure buildup within the plasma chamber 211 may impart a force onto the electrode 160 that overcomes the force imparted onto the electrode 160 by the spring 172, thereby forcing the electrode 160 and the nozzle 162 to separate from one another. As a result, the nozzle orifice 182 is exposed, and the first portion 206 of the plasma gas flow 200 may be discharged from the plasma chamber 211 and from the torch head 150 via the nozzle orifice 182.

After the electrode 160 and the nozzle 162 have been separated from one another, the increased speed of the first portion 206 of the plasma gas flow 200 through the plasma chamber 211 may help generate a plasma arc (e.g., the plasma arc 87) between the electrode 160 and the nozzle 162. The flow of the first portion 206 of the plasma gas flow 200 through the nozzle orifice 182 and the shield orifice 184 may help direct and constrain the plasma arc out of the torch head 150. Meanwhile, the shield gas flow 198 directed out of the shield orifice 184 may surround the first portion 206 of the plasma gas flow 200 directed through the shield orifice 184, as well as the plasma arc carried by the first portion 206 of the plasma gas flow 200. In this way, the shield gas flow 198 may block various external elements (e.g., ambient air) from adversely affecting the plasma arc created and sustained by the first portion 206 of the plasma gas flow 200. Thus, the shield gas flow 198 may help maintain and constrain the plasma arc and control the emission of the plasma arc.

Meanwhile, the second portion 208 of the plasma gas flow 200 can flow into the electrode 160 via an opening 212 and into a vent 214 of the electrode 160. The vent 214 directs the second portion 208 of the plasma gas flow 200 through the electrode 160 and into the insulator 170. The insulator 170 discharges the second portion 208 of the plasma gas flow 200 via an opening 216 of the insulator 170 and toward the cathode 154. The second portion 208 of the plasma gas flow 200 directed from the insulator 170 to the cathode 154 then flows across at least a portion of the spring 172 that is coupled to the insulator 170 and positioned between the insulator 170 and the cathode 154. The cathode 154 may receive the second portion 208 of the plasma gas flow 200 via a second opening 217 of the cathode 154 and may direct the second portion 208 of the plasma gas flow 200 into the body 152 via a second opening 218 of the body 152. The body 152 may then direct the second portion 208 of the plasma gas flow 200 through the anode conductor 180 and out of the torch head 150. For example, the body may direct the second portion 208 of the plasma gas flow 200 through an opening 220 of the anode conductor 180, into a discharge chamber 222 cooperatively formed by the body 152 and the outer shell 158, and out of the torch head 150 via a vent outlet 224 cooperatively formed by the body 152 and the outer shell 158.

The second portion 208 of the plasma gas flow 200 may provide substantial cooling for various components of the torch head 150 across which the second portion 208 of the plasma gas flow 200 is directed. Indeed, because the second portion 208 of the plasma gas flow 200 may not be directly exposed to the plasma arc formed between the electrode 160 and the nozzle 162, the second portion 208 of the plasma gas flow 200 may be at a relatively lower temperature as compared to the first portion 206 of the plasma gas flow 200. For this reason, the second portion 208 of the plasma gas flow 200 may have a relatively greater capacity to absorb heat. As an example, the second portion 208 of the plasma gas flow 200 may absorb heat from the electrode 160, from the insulator 170, from the spring 172, from the cathode 154, and/or from the body 152. Discharge of the second portion 208 of the plasma gas flow 200 from the torch head 150 (e.g., via the discharge chamber 222) may remove the heat from the torch head 150. However, similar advantages might also be achieved by venting the second portion 208 of the plasma gas flow 200 from the spring 172 to the vent outlet 224 in different manners.

The cooling of the torch head 150 provided by the second portion 208 of the plasma gas flow 200 may improve operation of the torch head 150. For example, cooling of the electrode 160 may reduce wear and/or degradation of the electrode 160. Thus, the electrode 160 may be able to generate a plasma arc more readily and/or desirably. Additionally or alternatively, reduced wearing of the electrode 160 may prolong a useful lifespan of the electrode 160. As such, the electrode 160 may be usable for a longer period of time and/or for a greater quantity of plasma torch operations. Thus, the torch head 150 may operate more efficiently, such as without being interrupted by downtime that may otherwise occur to perform maintenance on the electrode 160 (e.g., to replace the consumable stack 176). Moreover, cooling of the insulator 170 and/or of the spring 172 may enable the electrode 160 to move in a desirable manner relative to the nozzle 162. For instance, such cooling may maintain the structural integrity of the spring 172 to enable the spring 172 to impart a desirable amount of force that biases the electrode 160 toward the nozzle 162. Therefore, the capability of arc initiation based on the positioning of the electrode 160 relative to the nozzle 162 may be more desirable.

Furthermore, the flow of the second portion 208 of the plasma gas flow 200 downstream of the spring 172 toward the discharge chamber 222 may provide additional cooling benefits. As discussed herein, the cathode 154 directs the second portion 208 of the plasma gas flow 200 from the spring 172 to the body 152 and to the anode conductor 180 to flow to the discharge chamber 222 and out of the torch head 150. Therefore, the second portion 208 of the plasma gas flow 200, which may be at least partially heated as a result of heat transfer from the electrode 160, from the insulator 170, and/or from the spring 172, directed through the body 152 and/or through the anode conductor 180 may be at a relatively elevated temperature. However, the body 152 and/or the anode conductor 180 may not be exposed to or affected by a high temperature as compared to other components (e.g., the consumable stack 176) of the torch head 150. Thus, even though the body 152 and/or the anode conductor 180 may be exposed to the heated second portion 208 of the plasma gas flow 200, any heat transfer between the second portion 208 of the plasma gas flow 200 and the body 152 and/or the anode conductor 180 (e.g., to increase the temperature of the body 152 and/or of the anode conductor 180) may not affect operation of the plasma torch.

In view of this, the flow of the heated second portion 208 of the plasma gas flow 200 from the spring 172 to the body 152 and/or to the anode conductor 180 may result in more desirable heat removal (e.g., of the electrode 160, of the insulator 170, of the spring 172) as compared to, for example, flow of heated second portion 208 of the plasma gas flow 200 from the spring 172 to the electrode 160, which may reduce capacity of the second portion 208 of the plasma gas flow 200 to remove heat from the electrode 160 and therefore cooling of the electrode 160. That is, the cooling path presented herein may be advantageous as compared to a cooling path that traverses a spring prior to contacting electrode, which in turn, is cooled prior to a shield. However, to reiterate, similar advantages might also be achieved by venting the second portion 208 of the plasma gas flow 200 from the spring 172 to the vent outlet 224 in different manners.

In some embodiments, flow of the second portion 208 of the plasma gas flow 200 may also impart a force that urges movement of the electrode 160 away from the nozzle 162. As an example, the second portion 208 of the plasma gas flow 200 may impart a force onto the electrode 160 against the force imparted by the spring 172. Thus, the second portion 208 of the plasma gas flow 200 may also be used to control a position of the electrode 160 relative to the nozzle 162, such as during operation of the plasma torch. Indeed, a pressure and/or flowrate of the plasma gas, and therefore of the second portion 208 of the plasma gas flow 200, may be adjusted to adjust the position of the electrode 160 relative to the nozzle 162. By way of example, the pressure and/or flowrate of the plasma gas may be adjusted to maintain the position of the electrode 160 based on a condition (e.g., a structural integrity) of the electrode 160 and/or of the nozzle 162. For instance, as wearing of the electrode 160 increases to reduce extension of the electrode 160 toward the nozzle 162, the electrode 160 may be moved toward the nozzle 162 (e.g., the pressure and/or flowrate of plasma gas may be reduced to decrease the force imparted by the second portion 208 of the plasma gas flow 200) to maintain a threshold distance between the electrode 160 and the nozzle 162.

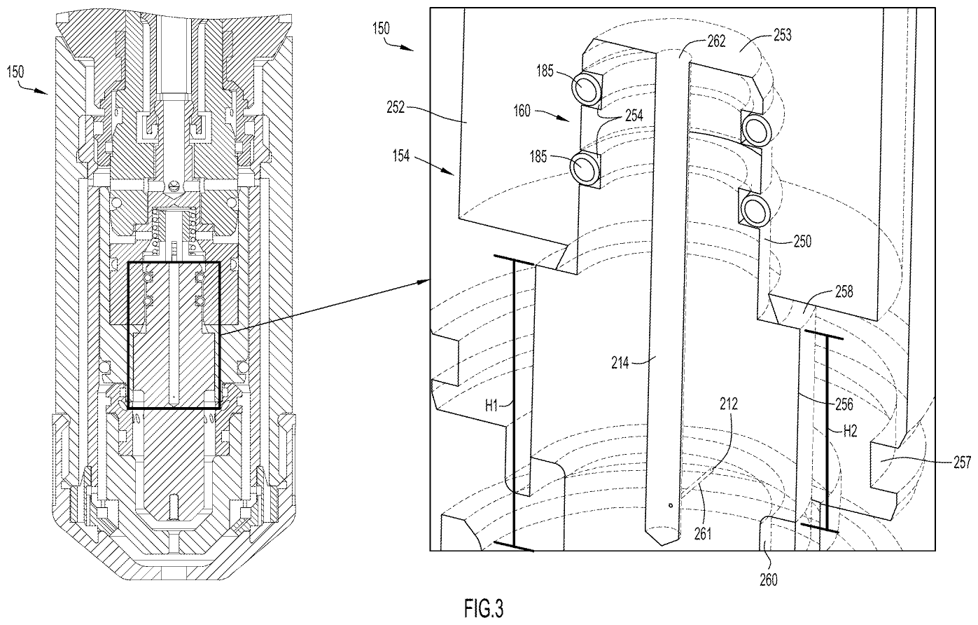

FIG. 3 is a cross-sectional view of a portion of the torch head 150. In particular, FIG. 3 provides a visualization of the interface between a proximal portion of the electrode 160 and the cathode 154. In the illustrated embodiment, the electrode 160 includes a proximal end 250, which may be positioned more adjacent to the body 152 (e.g., more distal to the nozzle 162) of the torch head 150 in the assembled configuration of the torch head 150. The proximal end 250 may extend into a space formed by a first section 252 of the cathode 154. The insulator 170 may be coupled to the proximal end 250, such as at a surface 253 of the proximal end 250. Additionally, the proximal end 250 may include recesses 254 configured to receive the coils 185. The coils 185 may engage the proximal end 250 and the first section 252 of the cathode 154 to facilitate movement (e.g., translation) between the first section 252 of the cathode 154 and the proximal end 250 of the electrode 160.

The electrode 160 may include a shouldered portion 256 extending from the proximal end 250. The shouldered portion 256 extends radially beyond the proximal end 250. That is, the shouldered portion 256 may be wider than the proximal end 250. Thus, the shouldered portion 256 may not be able to extend into the space formed by the first section 252 of the cathode 154. For instance, a surface 258 of the cathode 154 may abut against the shouldered portion 256 to block additional movement of the shouldered portion 256 toward the space formed by the first section 252 of the cathode 154. Instead, the shouldered portion 256 may extend into a space formed by a second section 257 of the cathode 154. The second section 257 has a longitudinal dimension H1 that is greater than a longitudinal dimension H2 of the shouldered portion 256 so that the shouldered portion 256 can move (e.g., translate) longitudinally within the second section 257 (e.g., in response to backpressure from the second portion 208 of the plasma gas flow 200).

The electrode 160 may further include a distal end 260 extending from the shouldered portion 256. The distal end 260 may be positioned more distal to the body 152 (e.g., more adjacent to the nozzle 162) in the assembled configuration of the torch head 150. In the illustrated embodiment, the shouldered portion 256 extends radially beyond the distal end 260. For instance, the proximal end 250 and the distal end 260 may have similar radii or widths (but may also have differing radii or widths). The distal end 260 may be in contact with the nozzle 162 prior to arc initiation. In addition, the distal end 260 may form a portion of the plasma chamber 211 that directs the first portion 206 of the plasma gas flow 200.

The vent 214 may extend from the proximal end 250, through the shouldered portion 256, and into the distal end 260 of the electrode 160. Additionally, the opening 212 of the electrode 160 may be formed through the distal end 260 to provide a channel 261 that directs plasma gas (e.g., the second portion 208 of the plasma gas flow 200 directed by the plasma gas distributor 166) to the vent 214. The vent 214 may then direct the plasma gas from the distal end 260, through the shouldered portion 256, and to the proximal end 250. The vent 214 may discharge the plasma gas from the electrode 160 via an outlet 262 formed through the surface 253. For example, the plasma gas may flow from the outlet 262 into and/or across the insulator 170 coupled to the surface 253 of the electrode 160.

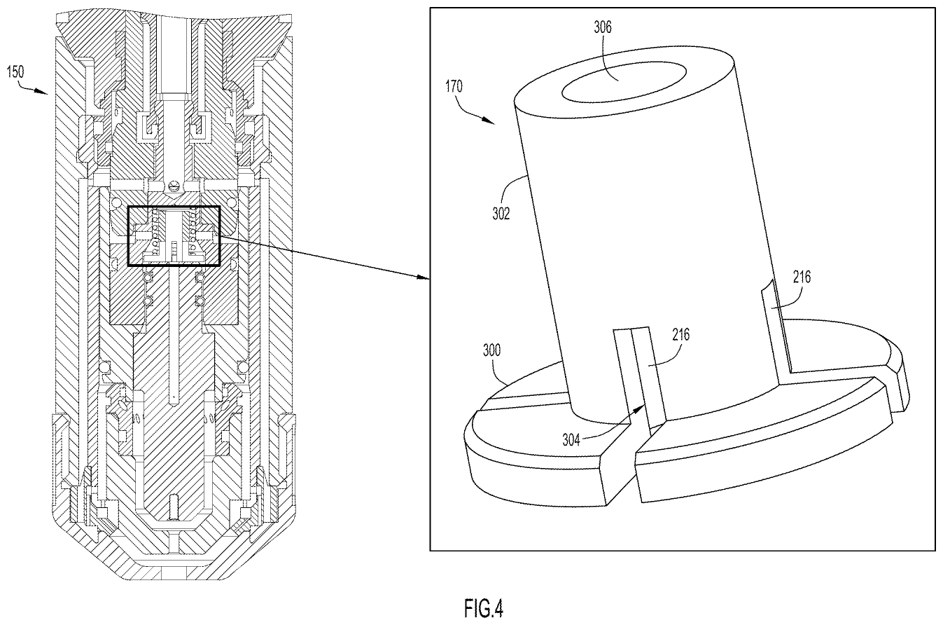

FIG. 4 is a perspective view of the insulator 170. The insulator 170 may include a base 300 and an extension 302 extending from the base 300. The base 300 may be configured to couple to the electrode 160 (e.g., to the surface 253 of the proximal end 250). Thus, the base 300 may initially receive the plasma gas discharged from the electrode 160. The insulator 170 may include an insulator chamber 304 extending through the base 300 and through the extension 302. The plasma gas may flow through the insulator chamber 304 and across interior walls of the insulator 170 to provide cooling of the insulator 170. Further, the insulator 170 may include multiple openings 216 that extend through each of the base 300 and the extension 302, and the plasma gas may flow through any of the openings 216 to flow out of the insulator chamber 304. For example, the plasma gas may flow through the openings 216 and across exterior walls of the insulator 170 to provide additional cooling of the insulator 170. Additionally or alternatively, the plasma gas may flow through the openings 216 and across the spring 172 coupled to the insulator 170 to provide cooling of the spring 172. In either case, the plasma gas may flow from the insulator 170 toward the cathode 154 (e.g., toward the second opening 217 of the cathode 154).

In additional or alternative embodiments, the insulator 170 may include an outlet 306 that may discharge the plasma gas from the insulator chamber 304. For example, the outlet 306 may enable plasma gas to flow out of the insulator chamber 304 and across the exterior walls of the insulator 170 and/or across the spring 172. Thus, each of the openings 216 and the outlet 306 may direct the plasma gas to provide additional cooling. For instance, the openings 216 and the outlet 306 may distribute plasma gas to flow across different portions of the spring 172 and/or of the exterior walls of the insulator 170 to improve overall cooling provided by the plasma gas.

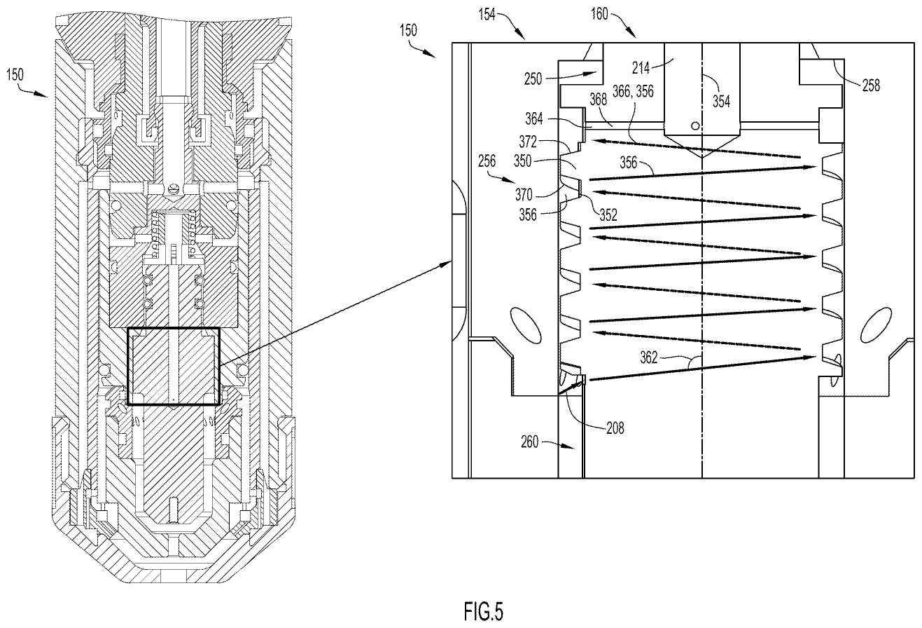

FIG. 5 is a cross-sectional view of a portion of the torch head 150. For example, FIG. 5 provides a visualization of the interface between a portion of the electrode 160 and the cathode 154. In the illustrated embodiment, the second portion 208 of the plasma gas flow 200 (e.g., received from the plasma gas distributor 166) may flow along multiple passes across the shouldered portion 256 of the electrode 160. Thus, a greater amount of surface area of the shouldered portion 256 may be in contact with the second portion 208 of the plasma gas flow 200. Increasing contact between the second portion 208 of the plasma gas flow 200 and the electrode 160 may impart a greater amount of force onto the electrode 160 to drive movement of the electrode 160 away from the nozzle 162. Additionally or alternatively, increasing contact between the second portion 208 of the plasma gas flow 200 and the electrode 160 may increase the cooling of the shouldered portion 256, and therefore of the electrode 160, via the plasma gas. The vent 214 may terminate more adjacent to the proximal end 250 to enable the flow of the second portion 208 of the plasma gas flow 200 along the multiple passes across the electrode 160 instead of directly though the vent 214. For example, the vent 214 may not extend to the distal end 260 of the electrode 160.

The shouldered portion 256 may include a fin 350 extending radially outward from a side surface 352 of the shouldered portion 256 that extends along a longitudinal axis 354 between the proximal end 250 and the distal end 260. In some embodiments, the fin 350 may extend around the side surface 352 in a helical or spiral manner. Therefore, the fin 350 may include different portions (e.g., passes) that are offset from one another along the longitudinal axis 354. The offset of different portions of the fin 350 may define a passageway 356 configured to direct the second portion 208 of the plasma gas flow 200 therethrough and along multiple passes. Each pass of the passageway 356 may extend at least partially toward the proximal end 250 to direct the second portion 208 of the plasma gas flow 200 from the distal end 260 toward the proximal end 250. For example, each pass of the passageway 356 may extend along the side surface 352 at an oblique angle 362 relative to the longitudinal axis 354. Thus, the fin 350 may form a thread-like configuration about the shouldered portion 256 that causes the second portion 208 of the plasma gas flow 200 to flow in a helical, a wave-like, or an oscillatory path along the shouldered portion 256 via the passageway 356.

Although the illustrated electrode 160 is described as having a single fin 350 defining the passageway 356 and extending along the side surface 352, an additional or alternative embodiment of the electrode 160 may include multiple fins. As an example, multiple fins may cooperatively define a single passageway (e.g., similar to the passageway 356) configured to direct the second portion 208 of the plasma gas flow 200 along the shouldered portion 256. As another example, multiple fins may define respective passageways or channels, which may be formed between adjacent fins. In such an example, certain fins may include openings to fluidly couple the respective passageways to one another to enable flow of the second portion 208 of the plasma gas flow 200 between different passageways and along the shouldered portion 256. That is, plasma gas may flow from passageway to passageway toward the proximal end 250.

An opening 364 may be formed through the shouldered portion 256 adjacent to the proximal end 250. The opening 364 may receive the second portion 208 of the plasma gas flow 200 from a most proximal pass 366 of the passageway 356. The opening 364 may be fluidly coupled to the vent 214 via a channel 368. Therefore, the opening 364 may direct the second portion 208 of the plasma gas flow 200 from the most proximal pass 366 of the passageway 356 into the vent 214, and the vent 214 may direct the second portion 208 of the plasma gas flow 200 toward the vent outlet 224.

The fin 350 may include a distal end facing surface 370 (e.g., a first surface, an upstream surface) and a proximal end facing surface 372 (e.g., a second surface, a downstream) extending along the side surface 352. The distal end facing surface 370 faces toward the distal end 260 of the electrode 160, and the proximal end facing surface 372 faces toward the proximal end 250 of the electrode 160. Advantageously, the distal end facing surface 370 and the proximal end facing surface 372 may be oriented in different manners relative to the side surface 352. For example, as discussed herein, a first angle formed between the distal end facing surface 370 and the longitudinal axis 354 may be different from a second angle formed between the proximal end facing surface 372. Indeed, although FIG. 5 is not meant to be to scale, the distal end facing surface 370 may have a flatter orientation that is more perpendicular relative to the longitudinal axis 354 as compared to the orientation of the proximal end facing surface 372. Such a difference in orientation of the distal end facing surfaces 370 and the proximal end facing surfaces 372 may enable the second portion 208 of the plasma gas flow 200 to impart an increased force onto the distal end facing surface 370 and toward the proximal end 250. Thus, the plasma gas may provide greater lift that urges movement of the shouldered portion 256, and therefore of the electrode 160, away from the nozzle 162 (e.g., prior to arc initiation).

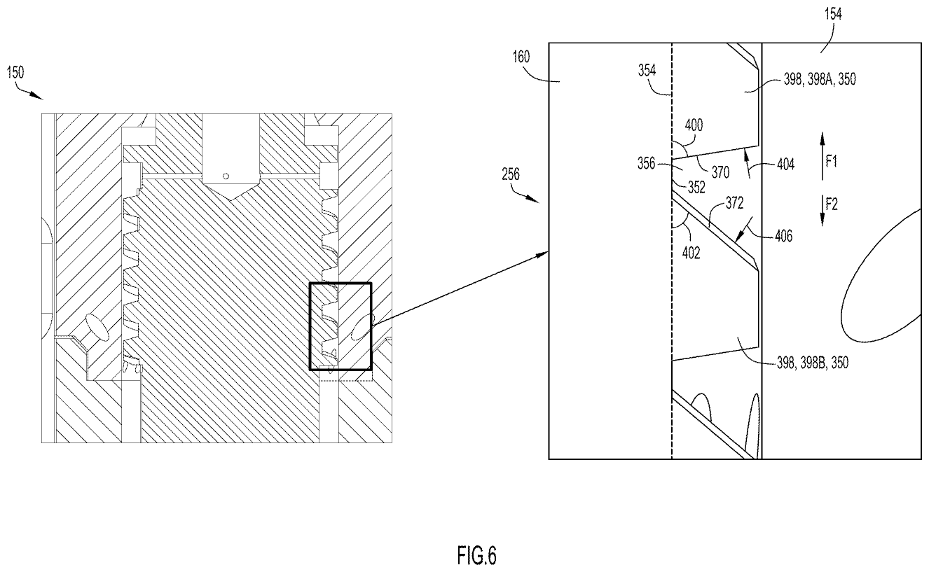

FIG. 6 is a cross-sectional view of a portion of the torch head 150 providing additional details with respect to the shouldered portion 256. For example, the distal end facing surface 370 of a first fin portion 398A (e.g., a proximal fin portion, a downstream fin portion), the proximal end facing surface 372 of a second fin portion 398B (e.g., a distal fin portion, an upstream fin portion) adjacent to the first fin portion 398A, and the side surface 352 may cooperatively define the passageway 356 through which plasma gas (e.g., the second portion 208 of the plasma gas flow 200) may flow. That is, the plasma gas may flow along the distal end facing surface 370 of the first fin portion 398A and along the proximal end facing surface 372 of the second fin portion 398B to flow through the passageway 356.

The distal end facing surface 370 and the proximal end facing surface 372 may extend toward the cathode 154 at different angles relative to the side surface 352. Therefore, each fin portion 398 may have an asymmetric orientation. For example, the distal end facing surface 370 may form a first angle 400 relative to the longitudinal axis 354 extending along the side surface 352, and the proximal end facing surface 372 may form a second angle 402 relative to the longitudinal axis 354. The first angle 400 may be greater than and more perpendicular than the second angle 402. For instance, the first angle 400 may be between 80 degrees and 90 degrees, between 75 degrees and 85 degrees, or between 70 degrees and 80 degrees, whereas the second angle 402 may be between 0 degrees and 30 degrees, between 15 degrees and 45 degrees, between 25 degrees and 55 degrees, or between 45 degrees and 75 degrees. Accordingly, the distal end facing surface 370 may extend relatively more laterally (e.g., perpendicularly relative to the longitudinal axis 354) toward the cathode 154, and the proximal end facing surface 372 may extend more longitudinally (e.g., along the longitudinal axis 354) toward the cathode 154. In other words, the distal end facing surface 370 may approach the cathode 154 more directly, whereas the proximal end facing surface 372 may approach the cathode 154 more angularly.

The orientation of the distal end facing surface 370 at the relatively greater first angle 400 may increase a force imparted by the plasma gas against the distal end facing surface 370 as compared to, for example, an embodiment in which the distal end facing surface 370 and the proximal end facing surface 372 are oriented at approximately the same angle relative to the side surface 352. For instance, plasma gas directed along the passageway 356 may impinge against both the distal end facing surface 370 and the proximal end facing surface 372. As such, the plasma gas may impart a force onto both the distal end facing surface 370 and the proximal end facing surface 372. By orienting the distal end facing surface 370 at the relatively greater first angle 400, the plasma gas may impart a greater force along the longitudinal axis 354 onto the distal end facing surface 370 than onto the proximal end facing surface 372. Indeed, because of the relatively more perpendicular orientation of the distal end facing surface 370 with respect to the longitudinal axis 354, impingement of the plasma gas against the distal end facing surface 370 in a first direction 404 toward the proximal end 250 (e.g., away from the nozzle 162) may provide a first force F1 that acts in a direction more aligned along the longitudinal axis 354 and toward the proximal end 250.

Additionally, because of the relatively more obliquely angled orientation of the proximal end facing surface 372 relative to the longitudinal axis 354, impingement of the plasma gas against the proximal end facing surface 372 in a second direction 406 toward the distal end 260 (e.g., toward the nozzle 162) may provide a second force F2 that acts in a direction more angled relative to (e.g., less aligned with) the longitudinal axis 354 and toward the distal end 260. As such, an amount of the first force F1 imparted onto the electrode 160 (e.g., the first fin portion 398A) along the longitudinal axis 354 and toward the proximal end 250 may be greater than an amount of the second force F2 imparted onto the electrode 160 (e.g., the second fin portion 398B) along the longitudinal axis 354 and toward the distal end 260. Therefore, the amount of the first force F1 along the longitudinal axis 354 may overcome the amount of the second force F2 along the longitudinal axis 354 to urge movement of the shouldered portion 256, and therefore of the electrode 160, in a corresponding direction along the longitudinal axis 354 and away from the nozzle 162.

Although the distal end facing surface 370 extends toward the proximal end 250 and toward the cathode 154 in the illustrated embodiment, the proximal end 250 may extend in any suitable manner toward the cathode 154 in an additional or alternative embodiment. As an example, the distal end facing surface 370 may extend from the side surface 352, toward the distal end 260, and toward the cathode 154. Nevertheless, the distal end facing surface 370 may be oriented more perpendicularly relative to the side surface 352 to enable the plasma gas directed through the passageway 356 to impart a greater amount of force toward the proximal end 250 than toward the distal end 260 along the longitudinal axis 354. As another example, the distal end facing surface 370 may extend in a non-planar manner, such as in an arcuate, a curved, or a step-like manner, but may nevertheless be oriented at the first angle 400 (e.g., based on an axis extending tangentially relative to the distal end facing surface 370 at the side surface 352) that is greater than the second angle 402 between the proximal end facing surface 372 and the side surface 352.

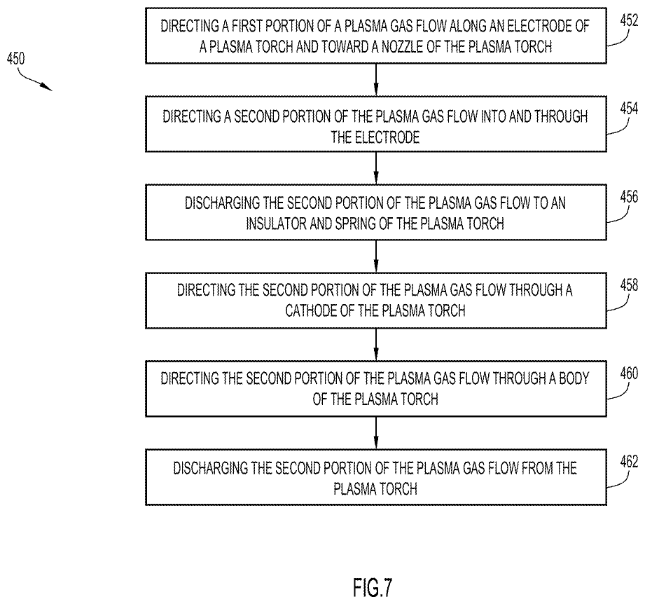

FIG. 7 is a flowchart of an example method 450 for directing plasma gas through the torch head 150. In particular, the method 450 describes the flow of the plasma gas flow 200 downstream of the plasma gas distributor 166. For example, performance of the method 450 may be effectuated by the structure of the torch head 150, such as the arrangement of various components of the torch head 150. It should be noted that the method 450 may be performed in a different manner in additional or alternative embodiments. For instance, additional operations may be performed with respect to the described method 450. Additionally or alternatively, certain steps of the depicted method 450 may be removed, modified, and/or performed in a different order.

At block 452, the first portion 206 of the plasma gas flow 200 is directed along the electrode 160 and toward the nozzle 162 for discharge from the torch head 150 via the nozzle orifice 182 and the shield orifice 184. At block 454, the second portion 208 of the plasma gas flow 200 is directed into the electrode 160 via the opening 212 of the electrode 160, from the opening 212 to the vent 214 via the channel 261 of the electrode, and through the vent 214 of the electrode 160. At block 456, the second portion 208 of the plasma gas flow 200 is discharged from the electrode 160 to the insulator 170 and the spring 172. For example, the second portion 208 of the plasma gas flow 200 may be directed into the insulator chamber 304 of the insulator 170, and the openings 216 of the insulator 170 may direct the second portion 208 of the plasma gas flow 200 across the spring 172. At block 458, the second portion 208 of the plasma gas flow 200 is directed from the spring 172 through the cathode 154 via the second opening 217 of the cathode 154. At block 460, the second portion 208 of the plasma gas flow 200 is directed from the cathode 154 through the body 152 via the second opening 218 of the body 152. At block 462, the second portion 208 of the plasma gas flow 200 is discharged from the torch head 150. For instance, the second portion 208 of the plasma gas flow 200 is directed from the body 152, through the opening 220 of the anode conductor 180, into the discharge chamber 222, and out of the torch head 150 via the vent outlet 224.

While the torch head presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. For example, as mentioned, the torch head presented herein may be modified to define a flow path that may direct plasma gas in any other suitable direction to provide cooling of different components of the plasma torch. Additionally, the torch head presented herein may be suitable for automated (e.g., mechanized) and/or manual (e.g., handheld) cutting.

In addition, various features from one of the embodiments may be incorporated into another of the embodiments. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the consumables described herein, or portions thereof may be fabricated from any suitable material or combination of materials, such as plastic or metals (e.g., copper, bronze, hafnium, etc.), as well as derivatives thereof, and combinations thereof.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc.). For example, the term “approximately” may denote a tolerance of plus or minus 0.002 inches, 0.001 inches, or up to 0.005 inches. The same applies to the terms “about” and “around” and “substantially.” Moreover, for the purposes of the present disclosure, the phrase “A and/or B” means (A), (B), or (A and B), and the phrase “A, B, and/or C” means (A), (B), (C), (A and B), (A and C), (B and C), or (A, B and C).

What is claimed is:

1. A torch head for a plasma torch, comprising:
an electrode comprising a vent formed therethrough, wherein the vent is configured to receive plasma gas and direct plasma gas through the electrode; and
a spring configured to bias the electrode toward a nozzle of the torch head, wherein the vent of the electrode is configured to discharge plasma gas across the spring.

2. The torch head of claim 1, comprising an insulator coupled to the electrode, wherein the spring is coupled to the insulator and is configured to bias the insulator toward the nozzle to bias the electrode toward the nozzle, and the vent of the electrode is configured to discharge plasma gas into the insulator.

3. The torch head of claim 2, wherein the insulator comprises an opening configured to discharge plasma gas across the spring.

4. The torch head of claim 1, comprising a cathode electrically coupled to the electrode, wherein the cathode is electrically coupled to the electrode, and the cathode comprises an opening configured to receive plasma gas discharged from the vent of the electrode and across the spring.

5. The torch head of claim 4, comprising a coil electrically coupled to the electrode, wherein the coil is configured to conduct electricity radially with respect to the electrode, from the cathode to the electrode.

6. The torch head of claim 4, comprising:
a body coupled to the cathode, wherein the body comprises an opening configured to receive plasma gas discharged from the cathode; and
an outer shell coupled to the body, wherein the outer shell at least partially defines a vent outlet configured to vent plasma gas discharged from the body.

7. The torch head of claim 1, comprising a distributor configured to direct the plasma gas into a plasma chamber where the plasma gas splits, such that the plasma gas flowing through the vent of the electrode is a first portion of the plasma gas and a second portion of the plasma gas flows along the electrode and toward the nozzle of the torch head.

8. The torch head of claim 7, comprising:
the nozzle, wherein the nozzle comprises a nozzle orifice; and
a shield, wherein the shield comprises a shield orifice, and the second portion of the plasma gas flows along the electrode, through the nozzle orifice, and through the shield orifice to discharge from the torch head.

9. The torch head of claim 8, comprising an additional distributor configured to direct process gas to the additional distributor, wherein the additional distributor is configured to direct a first portion of the process gas towards the electrode as the plasma gas and direct a second portion of the process gas between the nozzle and the shield and through the shield orifice.

10. The torch head of claim 9, comprising:
a cathode electrically coupled to the electrode, wherein the cathode is electrically coupled to the electrode;
a body coupled to the cathode, wherein the cathode comprises an opening configured to direct plasma gas to the body; and
an outer shell coupled to the body, wherein the outer shell at least partially defines a channel that directs plasma gas to the additional distributor.

11. The torch head of claim 1, wherein the electrode comprises:
a proximal end, a distal end, and a side surface extending at least partially between the proximal end and the distal end; and
a fin extending from the side surface, wherein the fin comprises:
a first surface facing the distal end, wherein the first surface extends at a first angle relative to the side surface; and
a second surface facing the proximal end, wherein the first surface and the second surface cooperatively define a passageway configured to direct plasma gas from the distal end, across the side surface, and toward the proximal end, the second surface extends at a second angle relative to the side surface, and the second angle is less than the first angle.

12. The torch head of claim 11, wherein the passageway is configured to direct plasma gas into the vent of the electrode.

13. The torch head of claim 12, wherein the vent does not extend to the distal end.

14. A method for directing plasma gas through a plasma torch, comprising:
directing a plasma gas flow into an electrode of the plasma torch via an opening of the electrode;
directing the plasma gas flow from the opening to a vent of the electrode; and
discharging the plasma gas flow from the vent of the electrode to a spring of the plasma torch, wherein the spring is configured to bias the electrode toward a nozzle of the plasma torch.

15. The method of claim 14, comprising directing the plasma gas flow from the spring toward a vent outlet of the plasma torch.

16. The method of claim 14, comprising:
directing the plasma gas flow from a distributor of the plasma torch into the electrode; and
directing an additional plasma gas flow from the distributor, along the electrode, and toward the nozzle.

17. The method of claim 14, comprising directing the plasma gas flow from the spring through a cathode of the plasma torch, wherein the cathode is configured to provide electrical power to the electrode.

18. The method of claim 17, comprising:
directing the plasma gas flow from the cathode through a body of the plasma torch, wherein the body is coupled to the cathode; and
discharging the plasma gas flow from the plasma torch via a vent formed at least partially by an outer shell coupled to the body.

19. An electrode for a plasma torch, comprising:
a proximal end, a distal end, and a side surface extending at least partially between the proximal end and the distal end; and
one or more fins extending from the side surface and defining a passageway between the distal end of the electrode and the proximal end of the electrode, wherein the passageway is configured to direct plasma gas from the distal end toward the proximal end, and the one or more fins comprise:
a first surface facing the distal end, wherein the first surface extends at a first angle relative to the side surface; and
a second surface facing the proximal end, wherein the first surface and the second surface cooperatively define the passageway, the second surface extends at a second angle relative to the side surface, and the second angle and the first angle are different from one another.

20. The electrode of claim 19, wherein the first angle is greater than the second angle.
